(19) United States
(12) Patent Application Publication
(10) Pub. No.: US 2024/0242336 A1
(43) Pub. Date: Jul. 18, 2024

(54) SYSTEM AND METHOD FOR PERFORMING QUALITY ASSURANCE OF DIFFERENT MANUFACTURING PRODUCTS

(71) Applicant: Dicky MASSEY, Dehli (IN)

(72) Inventor: Dicky MASSEY, Dehli (IN)

(21) Appl. No.: 18/412,277

(22) Filed: Jan. 12, 2024

(30) Foreign Application Priority Data
Jan. 12, 2023 (IN) 202311002609

(51) Int. Cl. G06T 7/00; G06Q 10/1093

(52) U.S. Cl. CPC G06T 7/001; G06Q 10/1093

(57) ABSTRACT

A system and method for performing QA of different manufacturing products is disclosed. The system mainly comprises of a user device, a client device, a computing environment, MR glasses with an AI camera, and an iQA platform. The user device is the device used by a designated user for carrying out the quality assurance (QA) of the packaged goods or the different manufacturing products. The user device is further configured to enable the designated user to carry out the QA, through the iQA platform. The designated user or users other than the designated user are the ones who register themselves through the iQA platform, by inputting their details to carry out the QA of a particular manufacturing product or a packaged good. The designated user is the user responsible to carry out the QA of the packaged goods or the different manufacturing products.

### CROSS-REFERENCE TO RELATED APPLICATIONS

This application claims a filing date of an earlier Indian Utility Model provisional application number 202311002609, filed on Jan. 12, 2023 as its priority date, which was submitted to Indian Patent Office (IPO). All contents or relevant subject matter of the priority application is hereby incorporated entirely or wherever appropriate by reference.

### TECHNOLOGICAL FIELD

Embodiments of the present invention generally relates to remote quality assurance systems and methods. Particularly, embodiments of the present invention relates to a system and method for performing quality assurance (QA) of different manufacturing products. More particularly, embodiments of the present invention relates to the system and method for performing the quality assurance of the different manufacturing products, through use of Mixed Reality (MR) technology driven by Artificial Intelligence (AI).

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

On-site factory inspections primarily focus on monitoring the manufacturing process and testing the physical condition of the resulting products for compliance with the client's requirements. In addition, they ensure that the products are properly packaged and correctly loaded for shipping and customs inspection at the destination. Pre-product inspections are carried out before production begins and up until 20% of production has been completed. Inspections of the factory by impartial third-party quality control inspectors help clarify production requirements and specifications, and firmly establish whether the manufacturer will be able to deliver on the promise to produce a quality product using the correct materials and manufacturing process. The primary key requirement during the quality inspection of the product is to inspect the first item to come off the production line at the factory. This is the first and last chance to physically inspect the final product and spot any defects so corrections can be made ahead of mass production. This inspection assesses whether the final product meets all the engineering, design, and specification requirements. The results are documented and sent to the client for verification.

Currently, carrying out and managing quality inspection of different manufacturing products have become a challenge for several reasons. There have been many remote quality inspection systems and methods developed in the recent past for carrying out the effective quality inspection of the different manufacturing products. One example of the remote quality inspection systems is use of tools with some sort of lens, potentially a light source, and either a viewing eyepiece or video transmission software so that the machine or site being examined can be viewed from a distance. These tools can have simple or rather complex designs, using technology like fibre optics or Web Real Time Communication (WebRTC).

Another example of the remote quality inspection systems is use of various types of equipment including borescopes, with or without video, visual support solutions, fibrescopes, remotely operated pan-tilt-zoom (PTZ) cameras, robotic cameras or tools, drones, and other data monitoring software, which allow technicians to analyze and visualize status of machines or products.

However, the existing remote quality inspection systems as described above are complex in terms of operation and design, and are not able to carry out quality inspection of the different manufacturing products in an effective manner. Moreover, these existing remote quality inspection systems involve use of the software which is not able to effectively handle quality inspection of the different manufacturing products at the same time remotely. Therefore, there exists a need of a remote inspection system and method which is configured to perform the quality inspection of the different manufacturing products in an effective manner, thereby providing accurate and quality inspection results.

### OBJECTS AND FEATURES OF THE INVENTION

Accordingly, several objects and advantages of present invention are to provide a system and a method for performing quality assurance (QA) of different manufacturing products addressing the above-mentioned needs. It is a further object and feature of the present invention to provide the system for performing the QA of the different manufacturing products, in order to provide accurate and precise QA results, while performing of the QA of the different manufacturing products. It is another object and feature of the present invention to provide the system for performing the QA of the different manufacturing products, through use of Mixed Reality (MR) technology driven by artificial intelligence (AI). It is still a further object and feature of the present invention to provide the system for automatically detecting the faults or defects in the different manufacturing products, while performing the QA of the different manufacturing products or packaged goods. Information related with the different manufacturing products or packaged goods are extracted from a picture order (PO) sheet. The PO sheet comprises of a list of packaged goods or manufactured products received by the client for inspection, a list of packaged goods or manufactured products which have been already inspected by the designated user, and a list of packaged goods or manufacturing products in the carton to be picked up by the designated user for inspection. Another object of the present invention is to provide the system for generating the QA report, based on the faults or defects in detected in the different manufacturing products. It is a further object and feature of the present invention to provide the system for providing grading associated with each of the different manufacturing products or the packaged goods to be inspected. Another object and feature of the present invention is to provide the system for notifying the designated user for carrying out the quality assurance (QA) of the packaged goods or the different manufacturing products. Further objects and features of the present invention will become apparent from a consideration of the drawings and ensuing description.

### BRIEF SUMMARY

Embodiments of the present disclosure are generally directed to a computer-implemented system for performing quality assurance (QA) of different manufacturing products. The system comprises of a client device, a user device, a computer-readable storage device, and an intelligent QA (iQA) platform. The user device is coupled to the client device, and the computer-readable storage device is coupled to the client device, the user device, and the one or more processors. The computer-readable storage device comprises instructions stored thereon which, when executed by the one or more processors, cause the one or more processors to perform operations performed by the iQA platform.

In one embodiment, the operations comprises uploading a picture order (PO) sheet of at least one packaged good or manufacturing product to be inspected at an inspection location facility, through the client device. The PO sheet is indicative of a desired state of a computing environment. The PO sheet is configured to be received by the designated user through MR glasses. The operations further comprises capturing images of the at least one packaged good or manufacturing product listed in the picture order sheet for inspection. The operations further comprises performing running of cloud functions of the computing environment by the designated user on the captured images, through the iQA platform to determine image characteristics of the at least one packaged good or manufacturing product. The operations further comprises comparing the image characteristics of the at least one packaged good or manufacturing product with image of the at least one packaged good or manufacturing product in the uploaded PO sheet, through the iQA platform. The operations further comprises detecting defects in the packaged goods or manufacturing products, through the iQA platform based on comparison of the determined image characteristics of the at least one packaged good or manufacturing product with the image of the at least one packaged good or manufacturing product in the uploaded PO sheet. The operations further comprises generating a QA report based on the detected defects in the at least one packaged good or manufacturing product, through a QA report generator. The operations further comprises determining a plurality of scores or grades associated with the at least one packaged good or manufacturing product based on the generated QA report, through a QA report analyzer.

In another embodiment, the PO sheet comprises a list of packaged goods or manufactured products received by the client for inspection, a list of packaged goods or manufactured products which have been already inspected by the designated user, and a list of packaged goods or manufacturing products in the carton to be picked up by the designated user for inspection.

In yet another embodiment thereof, the client device comprises of a client database and a web API, the client database configured to store data records related with the list of packaged goods or manufactured products received by the client for inspection, the list of packaged goods or manufactured products which have been already inspected by the designated user, and the list of packaged goods or manufacturing products in the carton to be picked up by the designated user for testing

In some embodiments, the iQA platform comprises a live QA feature, through which the client goes live with the QA process, and passes instructions to the designated user for performing the QA of the packaged goods or manufacturing products. The image characteristics of the packaged goods or manufacturing products are, but not limited to, colour, shape, size, pattern, and product labelling associated with the one or more packaged goods or manufacturing products.

In some embodiments, the iQA platform is further configured to detect location of the designated user and a specific time at which the designated user initiates the QA, while the designated user accesses through the computing environment to carry out the QA of the packaged goods or manufacturing products.

These and other embodiments can each optionally include one or more of the following features: the operation of uploading of the PO sheet through the client device comprises accessing the iQA platform by the client using account credentials, and displaying the PO sheet upon successful account verification of the client. Further, the operation of receiving the PO sheet by the designated user through the MR glasses comprises enabling the designated user to get access to the picture order sheet, through the client device, and displaying the PO sheet to the designated user, through the MR glasses. Further, the operation of determining the plurality of scores or grades associated with the at least one packaged good or manufacturing product based on the generated QA report, through the QA report analyzer comprises enabling the designated user to carry out the QA of the packaged goods or manufacturing products, by providing different control options to the designated user, through the iQA platform. Further, the operation of generating the QA report based on the detected defects in the at least one packaged good or manufacturing product, through the QA report generator comprises analyzing the QA report, through the QA report analyzer, by comparing the QA report with the image of the at least one packaged good or manufacturing product in the PO sheet, and collecting data related with the QA of the at least one packaged good or manufacturing product, through a data collector. The different control options are, but not limited to, local process, Standard Operating Procedures, Cloud functions, Feedback, and Voice Comments.

The present disclosure also provides a computer-readable storage medium coupled to one or more processors and having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided. The details of one or more implementations of the present disclosure are set forth in the accompanying drawings and the description below. Other features and advantages of the present disclosure will be apparent from the description and drawings, and from the claims.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and the detailed description are to be regarded as illustrative in nature and not as restrictive.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1A depicts a system for performing QA of different manufacturing products or packaged goods, in accordance with one embodiment of the present disclosure;

FIG. 1B depicts a system for performing the QA of the different manufacturing products or packaged goods, in accordance with another embodiment of the present disclosure;

FIG. 1C depicts a block diagram of a system illustrating components of a QA report generator, in accordance with one embodiment of the present disclosure;

FIG. 1D depicts a block diagram of a system illustrating events performed by an AI manager unit, in accordance with another embodiment of the present disclosure;

FIG. 1E depicts a block diagram of a system illustrating components of an AI core unit, in accordance with yet another embodiment of the present disclosure;

FIG. 2A is an example diagram depicting operation of a system for performing quality assurance of the different manufactured products or packaged goods, in accordance with one embodiment of the present disclosure;

FIG. 2B is an example diagram illustrating a system having an iQA platform running on a mobile device, in accordance with another embodiment of the present disclosure;

FIG. 3 depicts an example method for performing the quality assurance of the different manufactured products ore packaged goods, in accordance with an embodiment of the present disclosure;

FIG. 4 depicts a pictorial representation of an iQA platform window illustrating verification procedure for the designated user, in accordance with a first embodiment of the present disclosure;

FIG. 5 depicts a pictorial representation of an iQA platform window illustrating the verification procedure for the designated user, in accordance with a second embodiment of the present disclosure;

FIG. 6 depicts a pictorial representation of an iQA platform window illustrating QA test statistics, in accordance with a third embodiment of the present disclosure;

FIG. 7 depicts a pictorial representation of an iQA platform window illustrating products page and order registration page, in accordance with a fourth embodiment of the present disclosure;

FIG. 8 depicts a pictorial representation of an iQA platform window illustrating the product details, in accordance with a fifth embodiment of the present disclosure;

FIG. 9 depicts a pictorial representation of an iQA platform window illustrating the product details, in accordance with a sixth embodiment of the present disclosure;

FIG. 10 depicts a pictorial representation of an iQA platform window illustrating carton details, in accordance with a seventh embodiment of the present disclosure;

FIG. 11 depicts a pictorial representation of an iQA platform window illustrating a new order registration, in accordance with a eighth embodiment of the present disclosure;

FIG. 12 depicts a pictorial representation of an iQA platform window illustrating scheduled tests and completed tests, in accordance with a ninth embodiment of the present disclosure;

FIG. 13 depicts a pictorial representation of an iQA platform window illustrating device information, in accordance with a tenth embodiment of the present disclosure;

FIG. 14 depicts a pictorial representation of an iQA platform window illustrating registration details of the designated user, in accordance with an eleventh embodiment of the present disclosure;

FIG. 15 depicts a pictorial representation of an iQA platform window illustrating scheduled QA tests and completed QA tests, in accordance with a twelfth embodiment of the present disclosure;

FIG. 16 depicts a pictorial representation of an iQA platform window illustrating test registration details, in accordance with a thirteenth embodiment of the present disclosure;

FIG. 17 depicts a pictorial representation of an iQA platform window illustrating a QA report with status of different QA tests displayed, in accordance with a fourteenth embodiment of the present disclosure;

FIG. 18 depicts a pictorial representation of an iQA platform window illustrating upcoming QA tests along with displayed notifications, in accordance with a fifteenth embodiment of the present disclosure; and

FIG. 19 depicts a pictorial representation of a QA report illustrating inspection details and AI analysis test scores, in accordance with an embodiment of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, and referring to the Figures, exemplary embodiments of the subject technology comprise a system for performing quality assurance (QA) of different manufacturing products or packaged goods. As will be appreciated, features of the system provide various modes of operation of the system while carrying out the QA of the different manufacturing products or the packaged goods.

Reference will now be made in detail to specific embodiments or features, examples of which are illustrated in the accompanying drawings. Wherever possible, corresponding or similar reference numerals will be used throughout the drawings to refer to the same or corresponding parts. Moreover, references to various elements described herein, are made individually or collectively when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. $ 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

Embodiments of the present disclosure are generally directed to computer-implemented systems for performing the QA of the different manufacturing products or the packaged goods. More particularly, the embodiments of the present disclosure are directed to performing certain actions involved in carrying out the QA of the different manufacturing products, through use of Mixed Reality (MR) technology driven by artificial intelligence (AI), thereby ensuring accurate and precise QA results. In some embodiments, the actions include uploading a picture order (PO) sheet of at least one packaged good or manufacturing product to be inspected at an inspection location facility. The action further include receiving the PO sheet by a designated user through MR glasses. The action further include capturing images of the at least one packaged good or manufacturing product listed in the picture order sheet for inspection. The action further include performing running of cloud functions of the computing environment by the designated user on the captured images. comparing the image characteristics of the at least one packaged good or manufacturing product with image of the at least one packaged good or manufacturing product in the uploaded PO sheet. The action further include detecting defects in the packaged goods or manufacturing products, based on comparison of the determined image characteristics of the at least one packaged good or manufacturing product with the image of the at least one packaged good or manufacturing product in the uploaded PO sheet. The action further include generating a QA report based on the detected defects in the at least one packaged good or manufacturing product. The action further include determining a plurality of scores or grades associated with the at least one packaged good or manufacturing product based on the generated QA report.

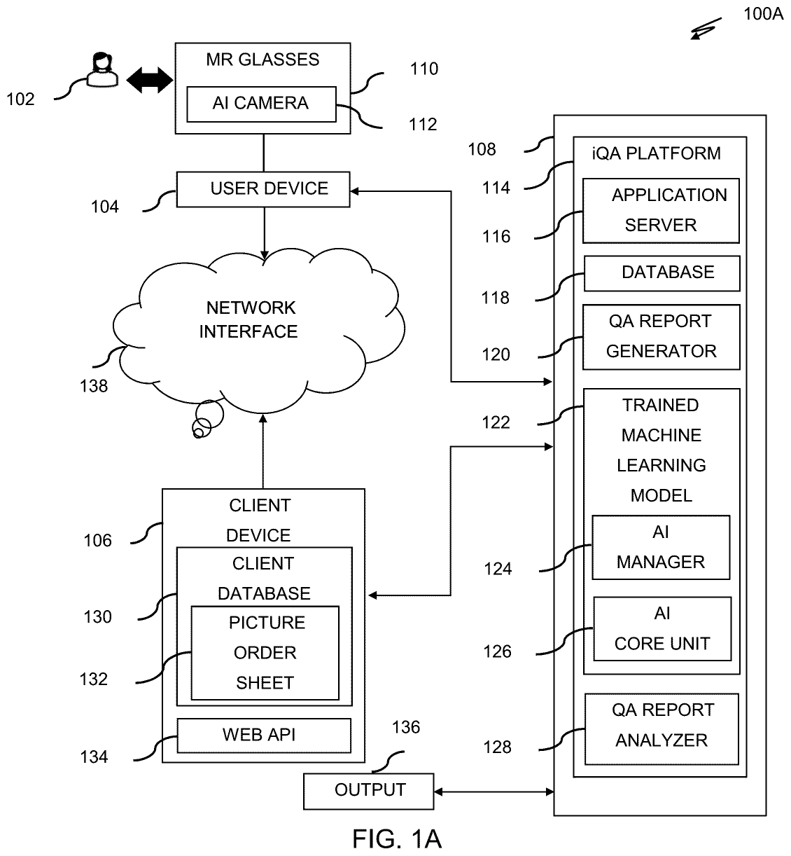

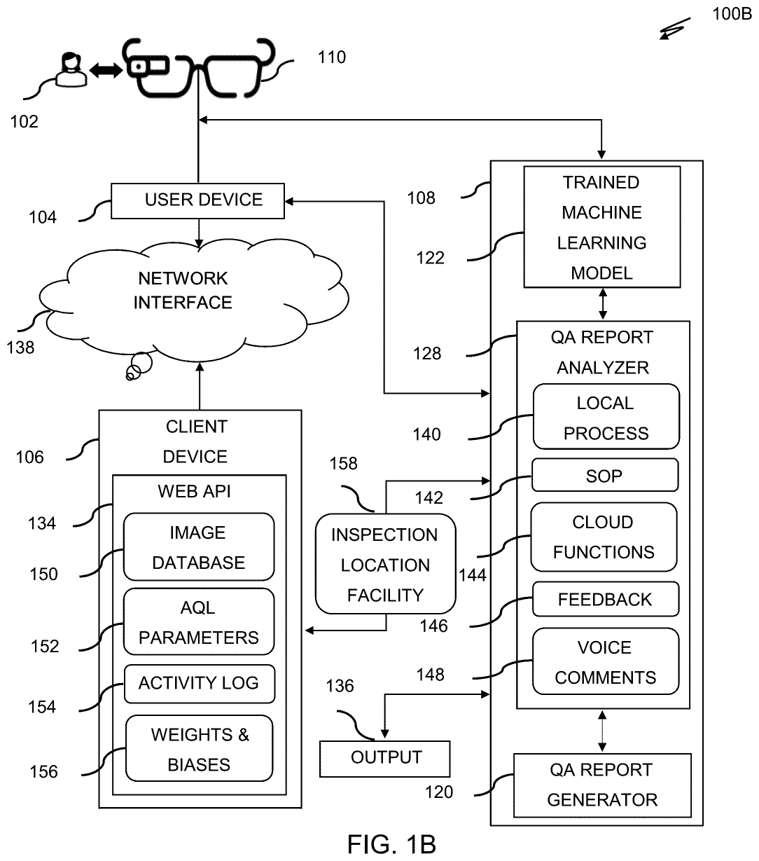

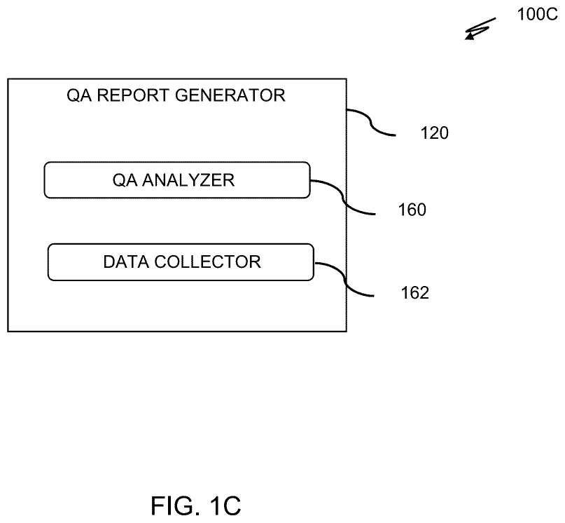

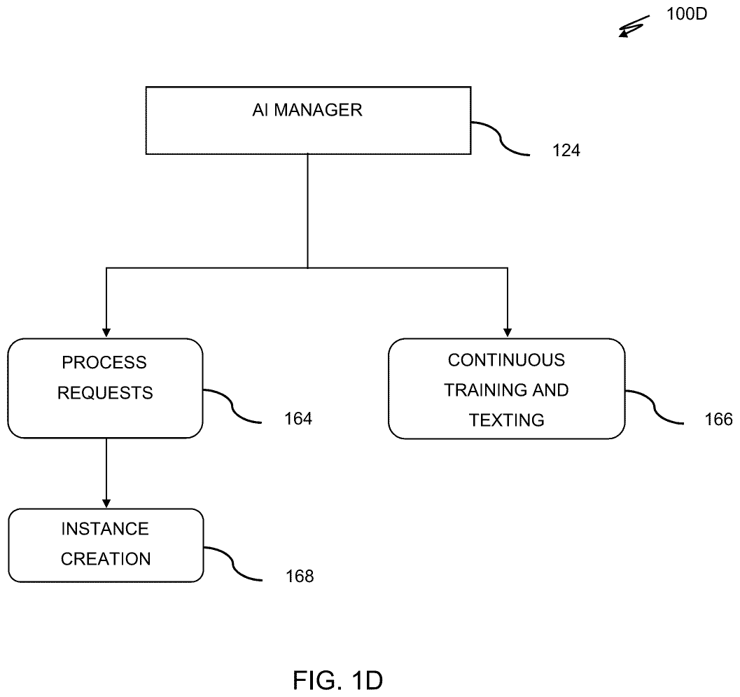

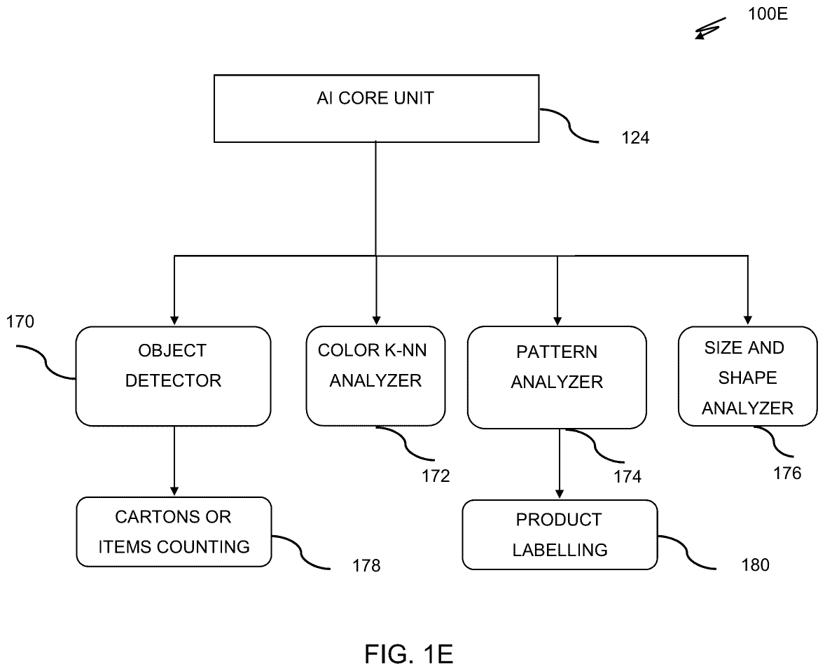

FIG. 1A depicts a system 100A for performing QA of different manufacturing products or packaged goods, in accordance with one embodiment of the present disclosure. The system 100A mainly comprises of a user device 104, a client device 106, a computing environment 108, Mixed Reality (MR) glasses 110 with an AI camera 112, and an iQA platform 114. The user device 104 is the device used by a designated user 102 for carrying out the quality assurance (QA) of the packaged goods or the different manufacturing products. The user device 104 is further configured to enable the designated user 102 to carry out the QA, through the iQA platform 114. The designated user 102 or users other than the designated user 102 are the ones who register themselves through the iQA platform 114, by inputting their details to carry out the QA of a particular manufacturing product or a packaged good. The designated user 102 is the user responsible to carry out the QA of the packaged goods or the different manufacturing products. The user device 104 is for example, but not limited to, a cellular phone, a mobile device, a laptop, a personal computer, a personal digital assistant (PDA), a tablet computer, a laptop computer, an Internet of Things (IoT), a smart watch, a mixed reality device, an augmented reality device, a virtual reality device, a multiple camera system, or any other handheld device.

The client device 106 is the device used by the client or administrator to guide the designated user 102 in carrying out the QA of the different manufacturing products or the packaged goods. The client device 106 is configured to be connected to the user device 104, through the computing environment 108. The client device 106 is for example, but not limited to, the cellular phone, the mobile device, the laptop, the personal computer, the personal digital assistant (PDA), the tablet computer, the laptop computer, the IoT, the smart watch, the mixed reality device, the augmented reality device, the virtual reality device, the multiple camera system, or any other handheld device.

The computing environment 108 is configured to be analyzed for the QA by the iQA platform 114 to initiate certain operations involved in conducting QA of the different manufacturing products or the packaged goods. The iQA platform 114, predicts particular manufacturing products or packaged goods for which QA needs to be conducted, through the computing environment 108, and at what time, and/or frequency. In some examples, the predictions are based on historical QA testing data. The iQA platform 114 is further configured to be connected with the computing environment 108, to identify list of cloud resources and application-level information. The list identifies the applications, and application servers configured within the computing environment 108. The application-level information can include, without limitation, application types, interconnections between applications, user accessibility for applications (e.g., which users have what access to an application for performing the QA of the different manufacturing products or the packaged goods).

In an embodiment, the client device 106 is further configured to enable the client to pass instructions to the designated user 102 through the iQA platform 114, while the designated user 102 is carrying out the QA of the different manufacturing products or the packaged goods.

In one embodiment, the client device 106 is configured to upload, through the iQA platform 114, a picture order (PO) sheet 132 associated with at least one packaged good or manufacturing product to be inspected at an inspection location facility (shown in FIG. 1B). The picture order sheet 132 comprises of a list of packaged goods or manufactured products received by the client for inspection, a list of packaged goods or manufactured products which have been already inspected by the designated user 102, and a list of packaged goods or manufacturing products in the carton to be picked up by the designated user 102 for inspection.

The client device 106 further comprises of an client database 130 and a web application program interface (API) 134, and is connected to the iQA platform 114 to guide the designated user 102 in carrying out the QA of the different manufacturing products or the packaged goods. The iQA platform 114 refers to the application installed and run in the user device 104 by the designated user 102, and in the client device 106 run by the client.

In an embodiment, the iQA platform 114 is configured to be communicably coupled to the user device 104 and the client device 106. The iQA platform 114 is further configured for uploading, through the client device 106, the PO sheet 132 associated with at least one packaged good or manufacturing product to be inspected at the inspection location facility. The iQA platform 114 is further configured for receiving, through the MR glasses 110, the picture order sheet 132 by the designated user 102. The iQA platform 114 is further configured for capturing, through an AI camera 112, images of the at least one packaged good or manufacturing product to be inspected from the picture order sheet 132. The iQA platform 114 is further configured for performing, through a trained machine learning model 122, running of cloud functions of the computing environment 108 by the designated user 102 on the captured images, to determine image characteristics of the at least one packaged good or manufacturing product. The iQA platform 114 is further configured for comparing, through the trained machine learning model 122, the image characteristics of the at least one packaged good or manufacturing product with image of the at least one packaged good or manufacturing product in the uploaded PO sheet 132. The iQA platform 114 is further configured for detecting, through the trained machine learning model 122, defects in the packaged goods or manufacturing products, based on comparison of the determined image characteristics of the at least one packaged good or manufacturing product with the image of the at least one packaged good or manufacturing product in the uploaded PO sheet 130. The iQA platform 114 is further configured for generating, through a QA report generator 120, a quality assurance (QA) report based on the detected defects in the at least one packaged good or manufacturing product. The iQA platform 114 is further configured for determining, through a QA report analyzer 128, a plurality of scores or grades associated with the at least one packaged good or manufacturing product, based on the generated QA report.

In an embodiment, the image characteristics of the packaged goods or manufacturing products are, but not limited to, colour, shape, size, pattern, and product labelling associated with the one or more packaged goods or manufacturing products.

In one embodiment, the iQA platform 114 mainly comprises of an application server 116, a database 118, the QA report generator 120, and the QA report analyzer 128.

In another embodiment, the iQA platform 114 is further configured to detect location of the designated user 102, and time at which the designated user 102 initiates the QA, while the designated user 102 logs in through the iQA platform 114 to carry out the QA of the packaged goods or manufacturing products.

The system 100 as depicted in the FIG. 1 comprises the MR glasses or MR headset 110 having the in-built AI camera 112. The MR glasses 110 are configured to be worn by the designated user 102 to see through packaged goods or manufacturing products clearly. The MR glasses 110 are further configured to enable the designated user 102 randomly select any packaged good or manufacturing product from catalogue or scheduled tests option in the iQA platform 114. The AI camera 112 is configured to capture images of the at least one packaged good or manufacturing product to be inspected.

The application server 116 is configured to process request made by the designated user 102 to connect with the client for carrying out the QA. The application server 116 is further configured to process request made by the client to upload the picture order sheet 132, through the iQA platform 114. The application server 116 is further configured to process request related to the inspection of the at least one packaged good or manufacturing product selected from the picture order sheet 132. The application server 116 is further configured to process request related to receiving of the picture order sheet 132 by the designated user 102 on the user device 104 from the client device 106. The application server 116 is further configured to process request made by the designated user 102 for selection of the at least one packaged good or manufacturing product to be inspected from a list of different manufacturing products.

The database 118 is configured to store the picture order sheet 132 uploaded by the client and received by the designated user 102, through the iQA platform 114. The database 118 is further configured to store data related with the list of packaged goods or manufactured products received by the client for inspection. The database 118 is further configured to store data related with the list of packaged goods or manufactured products which have been already inspected by the designated user 102. The database 118 is further configured to store data related with the list of packaged goods or manufacturing products in the carton to be picked up by the designated user 102 for inspection.

In an embodiment, the QA report generator 120 is configured to generate the QA report based on the detected defects in the at least one packaged good or manufacturing product.

The trained machine learning model 122 is configured to enable the designated user 102 to run the cloud functions of the computing environment 108 on the captured images, to determine image characteristics of the at least one packaged good or manufacturing product. The trained machine learning model 122 is further configured to compare the image characteristics of the at least one packaged good or manufacturing product with image of the at least one packaged good or manufacturing product in the uploaded PO sheet 132. The trained machine learning model 122 is further configured to detect defects in the packaged goods or manufacturing products, based on comparison of the determined image characteristics of the at least one packaged good or manufacturing product with the image of the at least one packaged good or manufacturing product in the uploaded PO sheet 132.

In one embodiment, the trained machine learning model 122 further comprises an AI manager 124 and an AI core unit 126.

The QA report analyzer 128 is configured to determine a plurality of scores or grades associated with the at least one packaged good or manufacturing product as an output 136, based on the generated QA report. The QA report analyzer 128 is further configured to analyze the generated QA report, by comparing the QA report with the image of the at least one packaged good or manufacturing product in the PO sheet 132. The QA report analyzer 128 is further configured to identify and generate data related with the QA of the at least one packaged good or manufacturing product.

The client database 130 is provided which is configured to store data records related with the list of packaged goods or manufactured products received by the client for carrying out the QA by inspection of the different manufacturing products or the packaged goods. The client database 130 is further configured to store data records related with the list of packaged goods or manufactured products which have been already inspected by the designated user 102. The client database 130 is further con figured to store data records related with the list of packaged goods or manufacturing products in the carton to be picked up by the designated user 102 for testing.

The user device 104, the client device 106, the computing environment 108, the MR glasses 110, and the iQA platform 114 are connected to each other over a network interface 138.

In some embodiments, the network interface 138 can be accessed over a wired and/or a wireless communications link. For example, mobile computing devices, like smartphones can utilize a cellular network to access the network interface 138.

In some embodiments, the network interface 138 may facilitate a communication link among the components of the system 100A. It can be noted that the network interface 138 may be a wired and/or a wireless network. The network interface 138, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art.

FIG. 1B depicts a system 100B for performing the QA of the different manufacturing products or packaged goods, in accordance with another embodiment of the present disclosure. The system 100B comprises of the user device 104, the client device 106, the iQA platform 114, and the MR glasses 110 connected to each other over the network interface 138. The iQA platform 114 is communicably coupled to the user device 104 and the client device 106 and configured for uploading, through the client device 106, the picture order (PO) sheet 132 associated with at least one packaged good or manufacturing product to be inspected at an inspection location facility 158. The client device 106 comprises the web API 134. The iQA platform 114 further comprises the QA report generator 120, the trained machine learning model 122, and the QA report analyzer 128. The QA report analyzer 128 is configured to analyze the QA process, by enabling the designated user 102 to carry out the quality assurance of the packaged goods or manufacturing products, by providing different control options to the designated user 102. These different control options are, but not limited to, a local process 140, a standard operating procedure SOP 142, cloud functions 144, a feedback 146, and voice comments 148.

The user device 104 may be configured to run through a voice command to take instructions from the client, and enable the designated user 102 to provide the voice comments 148 to be incorporated in the quality assurance report.

In an embodiment, the web API 134 is configured to enable the client or the administrator to select different options for controlling process of the quality assurance to be performed by the designated user 102. The different options for selection provided by the web API 134 are an image database option 150, AQL parameters option 152, activity log option 154, and weights and biases option 156.

The inspection location facility 158 is the location where the process of the QA is carried out by the designated user 102. At the inspection location facility 158, the designated user 102 starts the QA process by initiating inspection of the different packaged goods, or the manufacturing products uploaded by the client in the picture order sheet 132, through the iQA platform 114.

In an embodiment, the iQA platform 114 comprises of a live QA feature, through which the client or the administrator goes live with the QA, and passes instructions to the designated user 102 for performing the QA of the packaged goods or the manufacturing products.

FIG. 1C depicts a block diagram of a system illustrating components of the QA report generator 120, in accordance with one embodiment of the present disclosure. The report generator 120 further comprises a QA analyzer 160 and a data collector 162. The QA analyzer 160 is configured to analyze the quality assurance process by identifying results after comparing the generated QA report with the image of the at least one packaged good or the manufacturing product, to exactly detect the and spot out the defects in the at least one packaged good or the manufacturing product. The QA analyzer 160 is further configured to provide detailed analysis of the quality assurance results, based on the detected defects in the at least one packaged good or manufacturing product. The QA analyzer 160 is further configured to provide accurate quality assurance results for the at least one packaged good or the manufacturing product, based on the detected defects in the at least one packaged good or manufacturing product.

The data collector 162 is configured to collect data related with the list of packaged goods or manufactured products received by the designated user 102 for performing QA. The data collector 162 is further configured to collect data related with the list of packaged goods or manufactured products which have been already inspected by the designated user 102. The data collector module 162 is further configured to collect data related with the list of packaged goods or manufacturing products in the carton to be picked up by the designated user 102 for the QA.

FIG. 1D depicts a block diagram of a system 100D illustrating events performed by the AI manager 124, in accordance with another embodiment of the present disclosure. These events are process requests 164, continuous training and texting 166, and instance creation 168. The process requests 164 refers to the processing of the different requests made by the designated user 102 and the client. The process requests 164 may refer to the requests made by the designated user 102 or users to connect with the client for carrying out the QA. The process requests 164 may refer to the requests made by the client to upload the picture order sheet 132, through the iQA platform 114. The process requests 164 may refer to the requests made by the client to receive the picture order sheet 132 by the designated user 102. The process requests 164 may refer to the requests made by the designated user 102 for selection of the at least one packaged good or manufacturing product to be inspected from a list of different manufacturing products.

The continuous training and texting 166 may refer to the event of continuously training the iQA platform 114 by the AI manager 124, to provide data related to updated QA results after carrying out the inspection of the at least one packaged good or the manufacturing product. The continuous training and texting 166 may refer to the event of continuously training the iQA platform 114 by the AI manager 124, in a way that the information related to the list of packaged goods to be inspected, the list of packaged goods which have been already inspected, and the list of packaged goods which needs to be picked up for inspection is provided to the designated user 102 through text or notifications.

FIG. 1E depicts a block diagram of a system illustrating components of the AI core unit 126, in accordance with yet another embodiment of the present disclosure. The AI core unit 126 comprises of an object detector 170, a colour K-NN analyzer 172, a pattern analyzer 174, and a size and shape module analyzer 176. The object detector module 170 is configured to detect the object or the item or any manufacturing product or packaged good. The object detector 170 is further configured to detect cartons or item counting. The object detector 170 may be configured to detect total number of items or the packaged goods or the manufacturing products in a single carton or multiple cartons.

The colour K-NN analyzer 172 is configured to detect the colour of different items or the packaged goods or the manufacturing products. The colour K-NN analyzer 172 is further configured to detect variation in the colour of the different items or the packaged goods or the manufacturing products, based on the comparison of the determined image characteristics of the at least one packaged good or manufacturing product with the image of the at least one packaged good or manufacturing product in the uploaded PO sheet 132.

The pattern analyzer 174 is configured to detect the label of the at least one item or the packaged good or the manufacturing product. The pattern analyzer 174 is further configured to detect the brand of the at least one item or the packaged good or the manufacturing product, based on the labelling of the at least one item or the packaged good or the manufacturing product.

The size and shape analyzer 176 is configured to detect the size and shape of the at least one item or the packaged good or the manufacturing product. The size and shape analyzer 176 is further configured to detect the size and shape of the at least one item or the packaged good or the manufacturing product, based on the labelling of the at least one item or the packaged good or the manufacturing product.

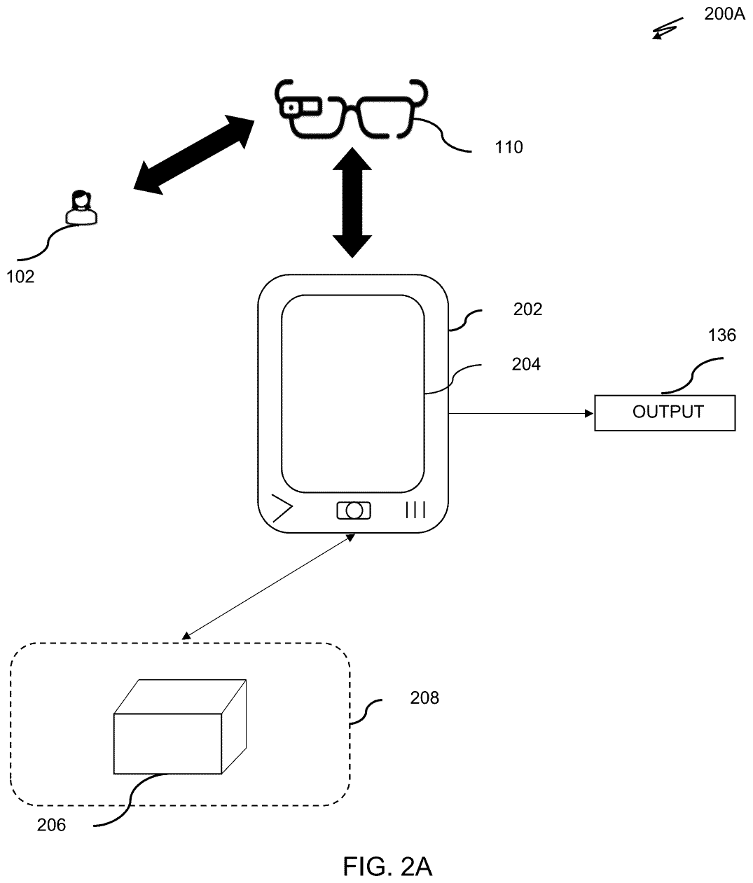

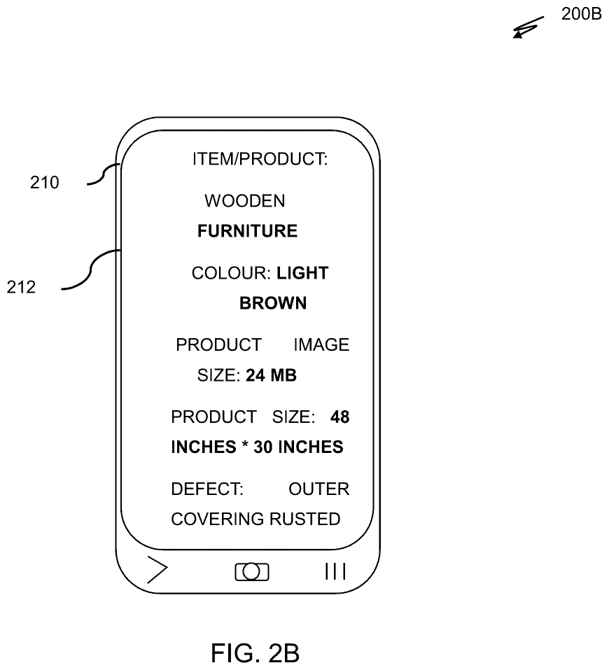

FIG. 2A is an example diagram depicting operation of a system 200A for performing quality assurance of the different manufactured products or packaged goods, in accordance with one embodiment of the present disclosure. The system 200A comprises of a user device 202, a software application window 204, a packaged good 206, and a QA facility 208. The packaged good 206 is configured to be scanned by the MR glasses 110, to get different images of the packaged good 206. These different images obtained are a blend of Augmented Reality (AR) based images and Virtual Reality (VR) based images. The software application window 204 is configured to display scanned images of the packaged good 206, as well as image characteristics of the packaged good 206. The image characteristics of the packaged good 206 are determined by the trained machine learning model 122 in-built in the iQA platform 114. Based on these image characteristics of the packaged good 206 in the QA facility 208, the designated user 102 carries out the quality assurance of the packaged good 206 by inspecting the packaged good 206 in the QA facility 208. The trained machine learning model 122 is further configured to automatically count the items or the products in the carton or items contained for that particular product order.

In one embodiment, the software application window 204 is configured to display various different control options to the designated user 102 to perform the QA effectively for the packaged goods or the different manufacturing products. These various control options are configured to enable the designated user 102 or other users to select any packaged good or the manufacturing product of their choice, for which the QA needs to be carried out, to give the output 136.

In another embodiment, the output 136 is the QA report generated based on the detected defects in the manufacturing product or the products or the packaged goods.

FIG. 2B is an example diagram illustrating a system 200B having a iQA platform 210 running on a mobile device, in accordance with another embodiment of the present disclosure. The iQA platform 210 is basically the AR software web-based application operating on the cloud-based infrastructure. The iQA platform 210 is configured to enable the designated user 102 or the buyer to register and access through the iQA platform 210 using his or her log in credentials. The client sets up the client device 106 in communication with the iQA platform 210 running in the user device 104, to guide the designated user 102 to use the iQA platform 210 effectively, while performing the quality assurance of the different manufacturing products by the designated user 102 or the buyer.

In one embodiment, an iQA platform window 212 is provided which is configured to display through display interface of the mobile device, the image characteristics of at least one packaged good or at least one manufacturing product. The image characteristics demonstrates the characteristics like the name of the at least one manufacturing product, the size of the at least one manufacturing product, the colour of the at least one manufacturing product, and various other characteristics.

The iQA platform 210 is composed of two components: one is the voice commander and another one is voice-controlled activity. The voice commander are the service interfaces directly in communication with raw Vuzix speech to initialize and maintain voice command. The voice commander comprises of specific defined commands to listen for like “SCAN” and “NEXT”. These captured events are sent to the respective activities “onCommand” function.

The voice-controlled activity is the component which utilizes the concepts of inheritance and encapsulation. The master or parent class implements all the base functionality on a screen or the activity that the designated user 102 might need. The voice-controlled activity of the iQA platform 210 is configured to initialize the voice commander, set up the text to speech, set up the speech to text, API services.

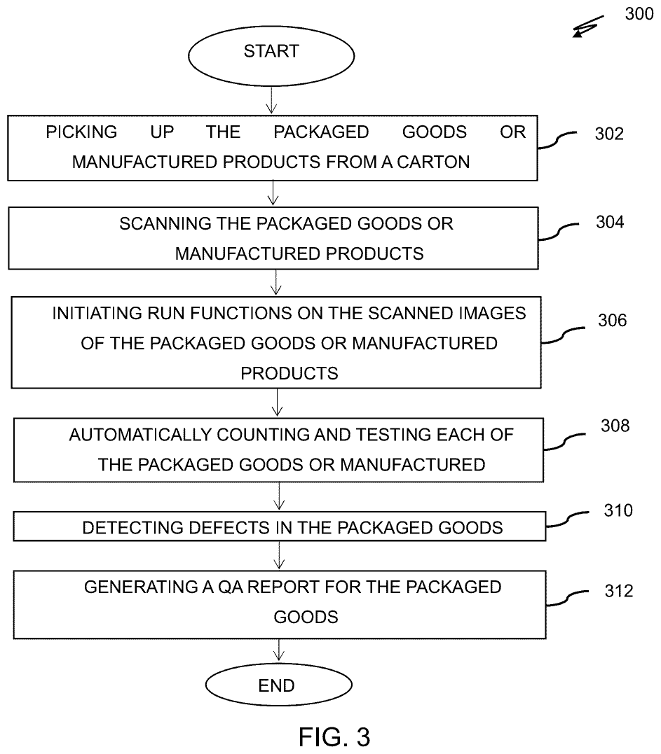

FIG. 3 depicts an example method 300 for performing the quality assurance of the different manufactured products ore packaged goods, in accordance with an embodiment of the present disclosure. The example method 300 as shown in FIG. 3 is basically a computer-implemented method of performing the QA of different manufacturing products by the iQA platform 114 executed by one or more processors. In the disclosed method 300, the PO sheet 132 of the at least one packaged good or manufacturing product to be inspected at the inspection location facility 158 is uploaded, through the client device 106, as illustrated by block 302. The PO sheet 132 is indicative of the desired state of the computing environment 108. The PO sheet 132 is received by the designated user 102 through the MR glasses 110, as illustrated by block 304. The PO sheet 132 is the sheet comprising information related with QA tests of the different manufacturing products or the packaged goods. For instance, the PO sheet 132 comprises of the list of packaged goods or manufactured products received by the client for inspection, the list of packaged goods or manufactured products which have been already inspected by the designated user 102, and the list of packaged goods or manufacturing products in the carton to be picked up by the designated user 102 for the inspection. The images of the at least one packaged good or manufacturing product listed in the picture order sheet 132 for inspection are captured using the AI camera 112, as illustrated by block 306. The running of cloud functions of the computing environment 108 are performed by the designated user 102 on the captured images, through the iQA platform 114 to determine the image characteristics of the at least one packaged good or manufacturing product, as illustrated by block 308. For instance, the image characteristics of the packaged goods or manufacturing products are, but not limited to, colour, shape, size, pattern, and product labelling associated with the one or more packaged goods or manufacturing products. The image characteristics of the at least one packaged good or manufacturing product are compared with image of the at least one packaged good or manufacturing product in the uploaded PO sheet, through the iQA platform 114, as illustrated by block 310. The defects are detected in the packaged goods or manufacturing products, through the iQA platform 114 based on comparison of the determined image characteristics of the at least one packaged good or manufacturing product with the image of the at least one packaged good or manufacturing product in the uploaded PO sheet 132, as illustrated by block 312. The QA report is then generated based on the detected defects in the at least one packaged good or manufacturing product, through the QA report generator 120, as illustrated by block 314. The plurality of scores or grades associated with the at least one packaged good or manufacturing product are determined based on the generated QA report, through the QA report analyzer 128, as illustrated by block 316.

The process of uploading of the PO sheet 132 through the client device 106 comprises accessing the iQA platform 114 by the client using account credentials, and displaying the PO sheet 132 upon successful account verification of the client. Furthermore, the process of receiving the PO sheet 132 by the designated user 102b through the MR glasses 110 comprises enabling the designated user 102 to get access to the picture order sheet 132, through the client device 106. The process further comprises displaying the PO sheet 132 to the designated user 102, through the MR glasses 110.

In an embodiment, the process of determining the plurality of scores or grades associated with the at least one packaged good or manufacturing product based on the generated QA report, through the QA report analyzer 128 comprises enabling the designated user 102 to carry out the QA of the packaged goods or manufacturing products, by providing different control options to the designated user 102, through the iQA platform 114.

In one embodiment, the process of generating the QA report based on the detected defects in the at least one packaged good or manufacturing product, through the QA report generator 120 further comprises analyzing the QA report, through the QA report analyzer 128, by comparing the QA report with the image of the at least one packaged good or manufacturing product in the PO sheet 132, and collecting data related with the QA of the at least one packaged good or manufacturing product, through the data collector 162.

In another embodiment, the process of determining the plurality of scores or grades associated with the at least one packaged good or manufacturing product based on the generated QA report, through the QA report analyzer 128 further comprises classifying the quality of the at least one packaged good or manufacturing product under a specific category, through the QA report analyzer 128, and displaying the specific category of the at least one packaged good or manufacturing product, through the iQA platform 114. For instance, the specific category of the at least one packaged good or manufacturing product comprises classification level of the at least one packaged good or manufacturing product.

In yet another embodiment, the step of performing running of cloud functions of the computing environment 108 by the designated user 102 on the captured images, through the iQA platform 114 to determine the image characteristics of the at least one packaged good or manufacturing product further comprises detecting location of the designated user 102 and a specific time at which the designated user 102 initiates the QA, through the iQA platform 114, while the designated user 102 logs in through the iQA platform 114 to carry out the QA of the packaged goods or manufacturing products.

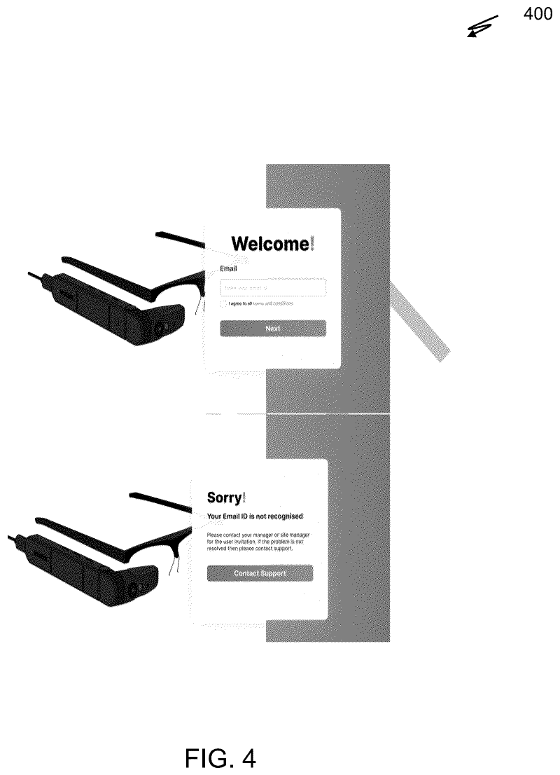

FIG. 4 depicts a pictorial representation of an iQA platform window 400 illustrating verification procedure for the designated user 102, in accordance with a first embodiment of the present disclosure. The iQA platform window 400 displays an application interface showing a login page when the designated user 102 logs in through the iQA platform 114 for performing the QA. As shown, after the designated user 102 logs in through the iQA platform 114, if the login credentials are correct, the designated user 102 is successfully verified through the iQA platform 114, and access through the iQA platform 114. If the login credentials are incorrect, the application interface displays “Your Email ID is not recognized”.

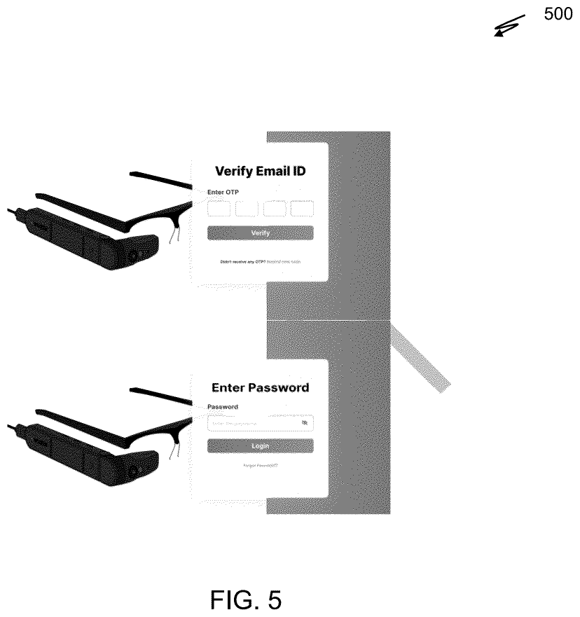

FIG. 5 depicts a pictorial representation of an iQA platform window 500 illustrating the verification procedure for the designated user 102, in accordance with a second embodiment of the present disclosure. The iQA platform window 500 displays the application interface showing the login page at the time when the designated user 102 accesses through the iQA platform 114 for performing the QA. As shown, in an instance, when the designated user 102 opens the iQA platform 114, the login credentials are displayed on screen of the user device 104 of the designated user 102. These login credentials are displayed as “Verify Email ID” and “Enter Password”.

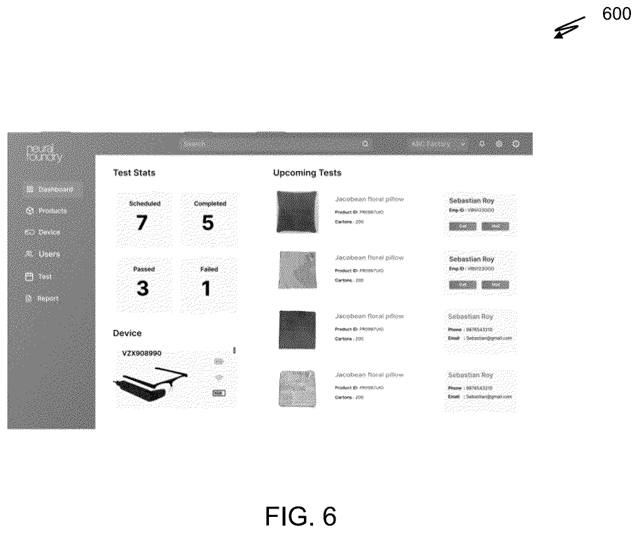

FIG. 6 depicts a pictorial representation of an iQA platform window 600 illustrating QA test statistics, in accordance with a third embodiment of the present disclosure. The iQA platform window 600 shows number of different tests listed under the test statistics. These different tests are “SCHEDULED TESTS”, “COMPLETED TESTS”, “PASSED TESTS”, and “FAILED TESTS”. As shown in FIG. 6, the number of scheduled QA tests are six, the number of completed QA tests are five, the number of passed QA tests are three, and the number of failed QA tests is one. Different upcoming QA tests are also shown which lists the products for which the QA is performed and name of the designated user 102 or quality assurer who is entitled to perform the QA test.

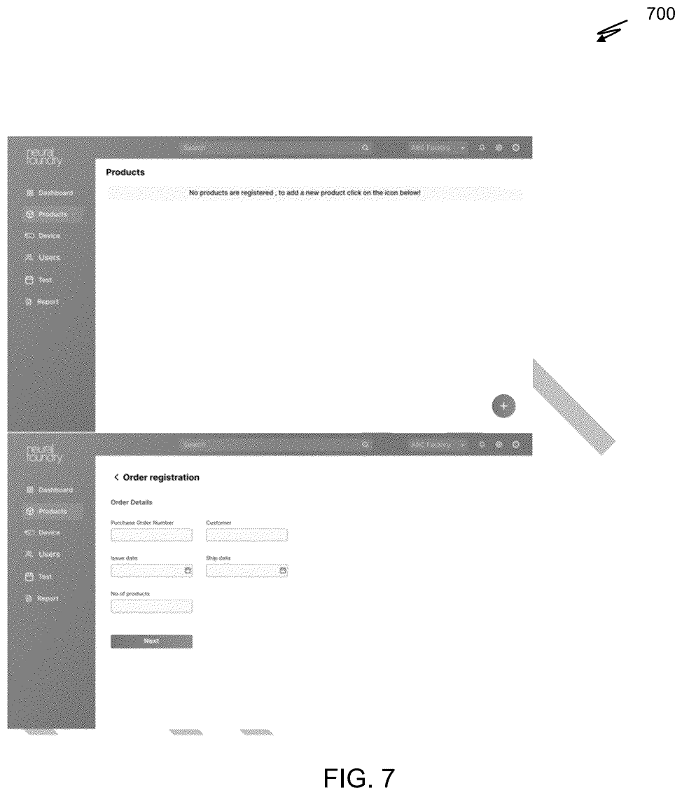

FIG. 7 depicts a pictorial representation of an iQA platform window 700 illustrating products page and order registration page, in accordance with a fourth embodiment of the present disclosure. The iQA platform window 700 displays the application interface showing that there are no products listed out for which the QA test needs to be conducted. The “Order Registration” page is the page which displays order details to be filled by the designated user 102. These order details are, but not limited to, purchase order number, customer name, order issue date, order ship date, and number of products.

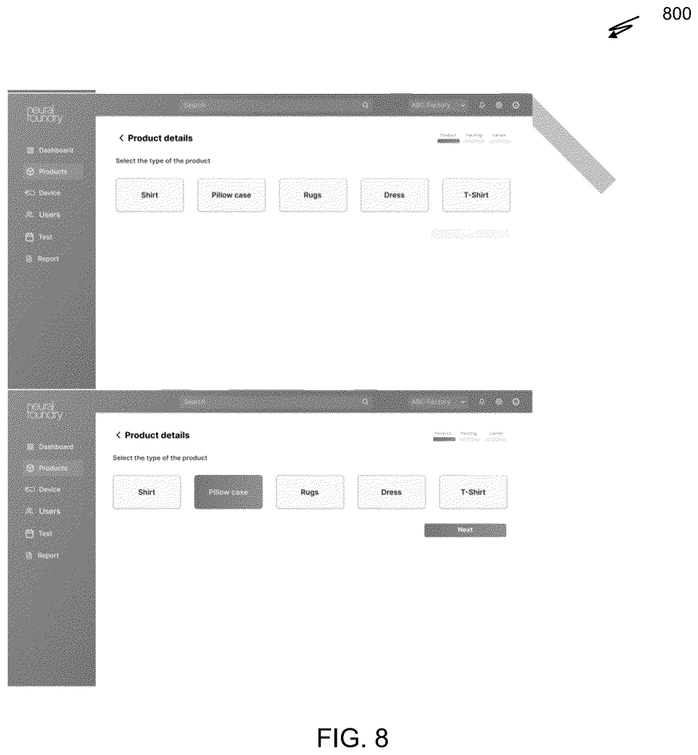

FIG. 8 depicts a pictorial representation of an iQA platform window 800 illustrating the product details, in accordance with a fifth embodiment of the present disclosure. The iQA platform window 800 displays the application interface showing the product details like “type of the product” to be selected for the QA.

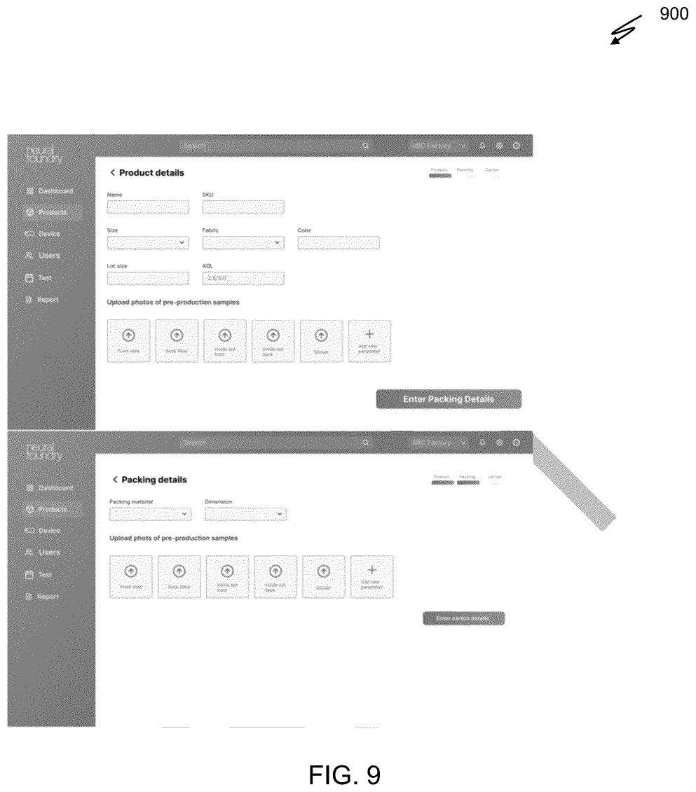

FIG. 9 depicts a pictorial representation of an iQA platform window 900 illustrating the product details, in accordance with a sixth embodiment of the present disclosure. The iQA platform window 900 displays the application interface showing the product details and the packing details to be filled by the designated user 102 for carrying out the QA. For instance, the iQA platform window 900 comprises of the product details like product name, size of the product, fabric used for the product, lot size, and images of the product to be uploaded for performing the QA.

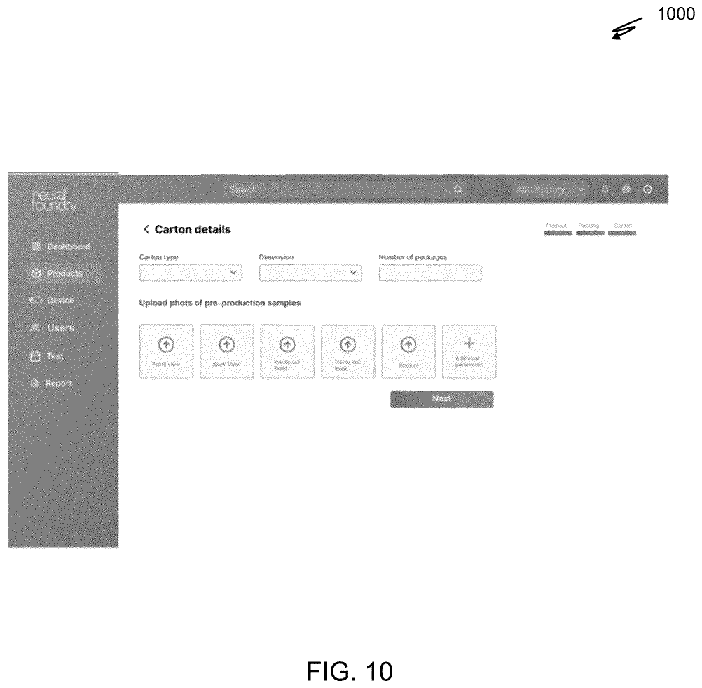

FIG. 10 depicts a pictorial representation of an iQA platform window 1000 illustrating carton details, in accordance with a seventh embodiment of the present disclosure. The iQA platform window 1000 comprises of the application interface displaying the carton details like carton type, carton dimensions, number of packages, and images of the pre-production sample packed in the carton. The carton type refers to class of the carton in which the product or products are packaged and needs to be inspected.

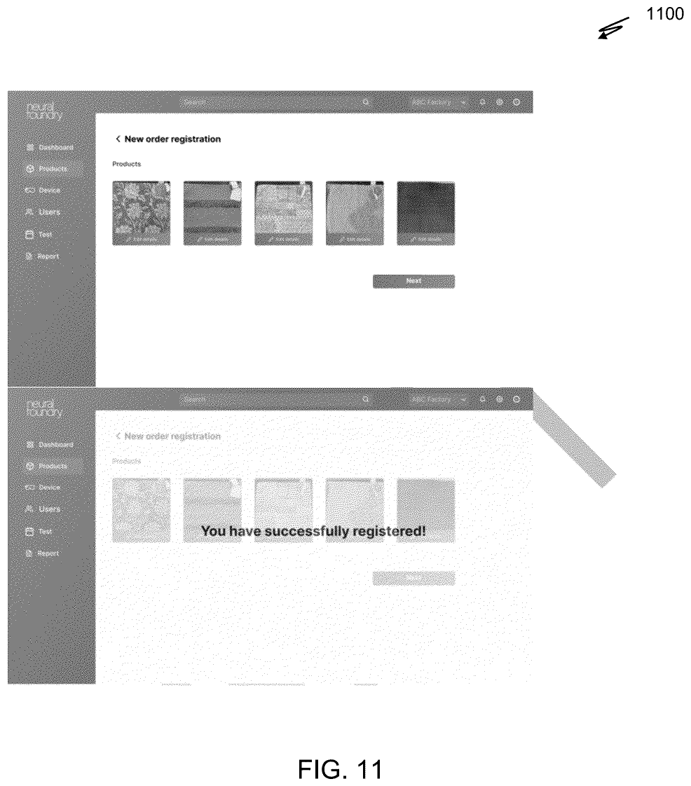

FIG. 11 depicts a pictorial representation of an iQA platform window 1100 illustrating a new order registration, in accordance with a eighth embodiment of the present disclosure. The iQA platform window 1100 comprises of the application interface showing the information related with new product order registration. The information related with the new product order registration refers to the product or products to be selected for inspection. After selection of a particular product for the inspection, a new order registration page is displayed showing that the designated user 102 has “SUCCESSFULLY REGISTERED”.

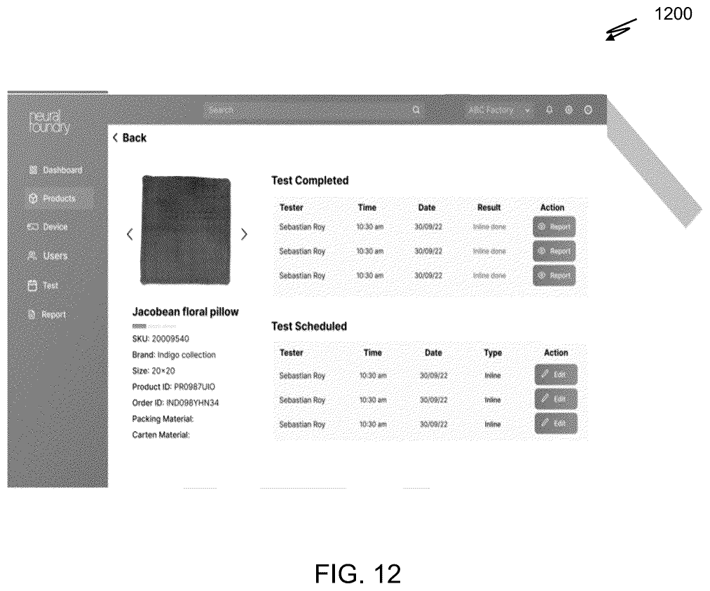

FIG. 12 depicts a pictorial representation of an iQA platform window 1200 illustrating scheduled tests and completed tests, in accordance with a ninth embodiment of the present disclosure. The iQA platform window 1200 comprises of the application interface showing the particular product for which the details are generated, upon selecting the particular product by the designated user 102 for inspection. For instance, the particular product selected by the designated user 102 for inspection is displayed as “JACOBEAN FLORAL PILLOW”. Additionally, the page as displayed by the iQA platform window 1200 shows the number of completed tests and the scheduled tests, as well as information alongside the number of completed tests and the number of scheduled tests. For instance, the information alongside the number of completed tests and the scheduled tests is shown which is the QA person or the designated user 102 who completed the QA test and is going to perform the next QA test which is already scheduled, date of the completed QA test or the scheduled QA test, the time of carrying out the completed QA test, the time decided for the designated user to carry out the scheduled test, and updated action/status of the completed QA test or the scheduled QA test.

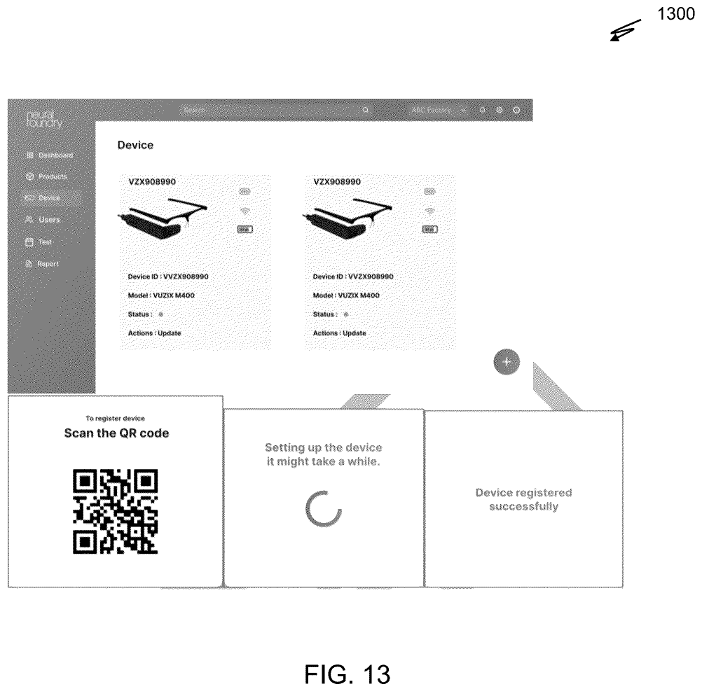

FIG. 13 depicts a pictorial representation of an iQA platform window 1300 illustrating device information, in accordance with a tenth embodiment of the present disclosure. The iQA platform window 1300 comprises of the application interface configured to display the device information, which is the device used by the designated user 102, i.e., the user device 104, the device used by the client, i.e., the client device 106, model number of the user device 104, model number of the client device 106.

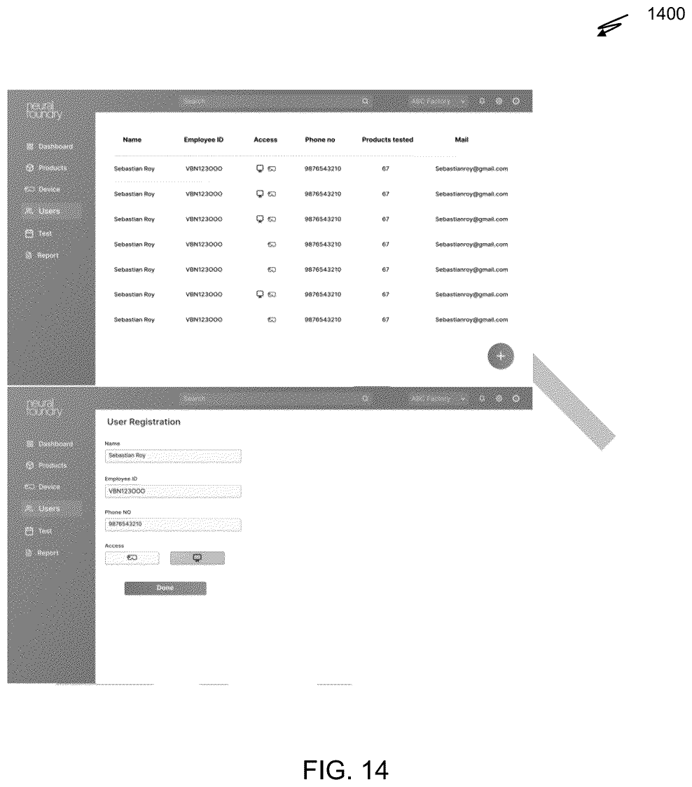

FIG. 14 depicts a pictorial representation of an iQA platform window 1400 illustrating registration details of the designated user 102, in accordance with an eleventh embodiment of the present disclosure. The iQA platform window 1400 is configured to display information related with the registration details of the designated user 102. The information related with the registration details of the designated user 102 is shown as name of the designated user 102 carrying out the QA test, employee ID of the designated user 102, contact details of the designated user 102, and access options for the designated user 102 to get connected with the client device 106.

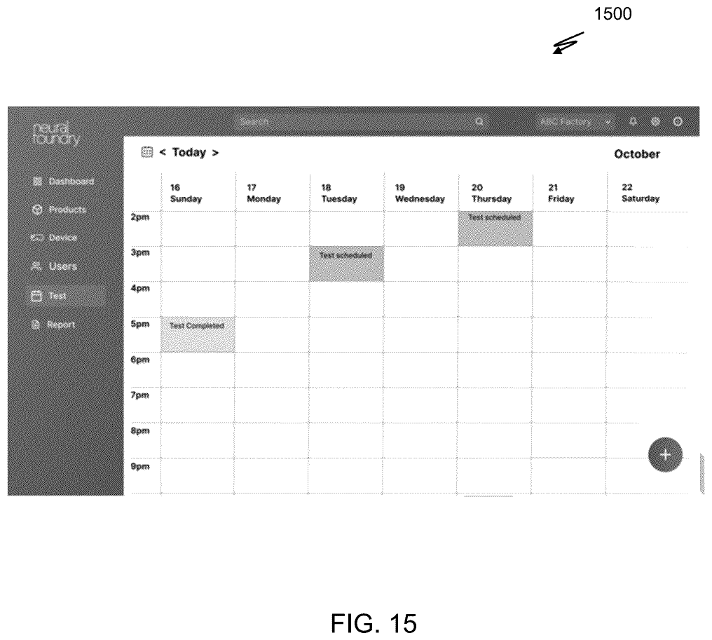

FIG. 15 depicts a pictorial representation of an iQA platform window 1500 illustrating scheduled QA tests and completed QA tests, in accordance with a twelfth embodiment of the present disclosure. The iQA platform window 1500 comprises of the application interface configured to display the calendar slot in which the QA tests which have been both completed and scheduled are mentioned in the calendar along with the date of the completed QA test and the date of the scheduled QA test.

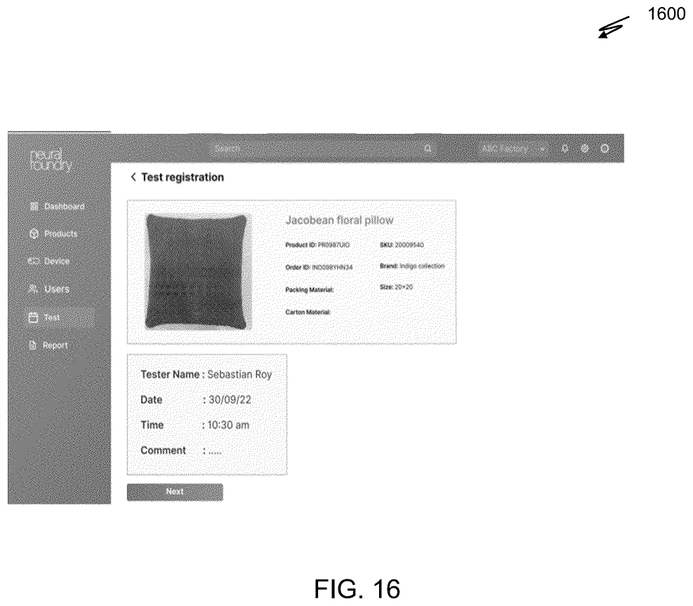

FIG. 16 depicts a pictorial representation of an iQA platform window 1600 illustrating test registration details, in accordance with a thirteenth embodiment of the present disclosure. The iQA platform window 1600 comprises of the application interface configured to display the information related with the product test like product tester name, product ID, product brand, product size, comment added by the product tester while carrying out QA, and the like.

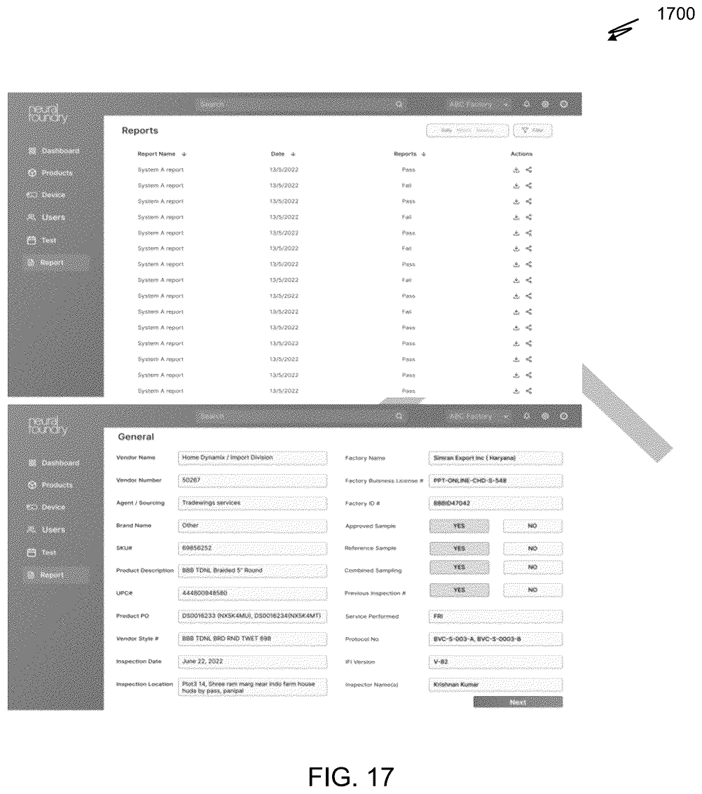

FIG. 17 depicts a pictorial representation of an iQA platform window 1700 illustrating a QA report with status of different QA tests displayed, in accordance with a fourteenth embodiment of the present disclosure. The iQA platform window 1700 comprises of the application interface configured to display the information displayed in the QA report like vendor name, vendor number, agent/sourcing company, brand, product description, vendor style, inspection date, inspection location, factory name, factory ID, factory business license, service performed, protocol number, inspector name, and the like.

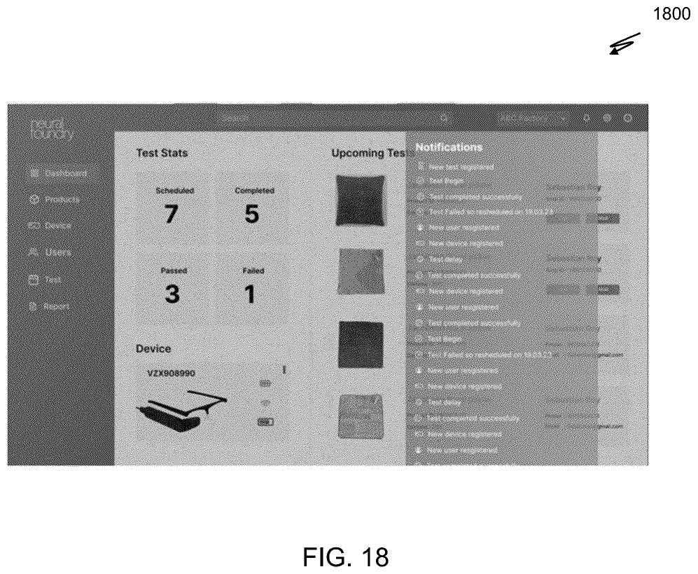

FIG. 18 depicts a pictorial representation of an iQA platform window 1800 illustrating upcoming QA tests along with displayed notifications, in accordance with a fifteenth embodiment of the present disclosure. The iQA platform window 1800 comprises of the application interface configured to display the information related with the upcoming QA tests and the displayed notifications. The information related with the upcoming QA tests is shown which includes QA tester name, QA tester ID, the product to be inspected, the product ID, total number of products, and the like. The information related with the displayed notifications is the information displaying the options under the notifications. For instance, the options displayed under the notifications are, but not limited to, “NEW TEST REGISTERED”, “TEST BEGIN”, “TEST COMPLETED SUCCESSFULLY”, “NEW USER REGISTERED”, “NEW USER REGISTERED”, “NEW DEVICE REGISTERED”, and the like.

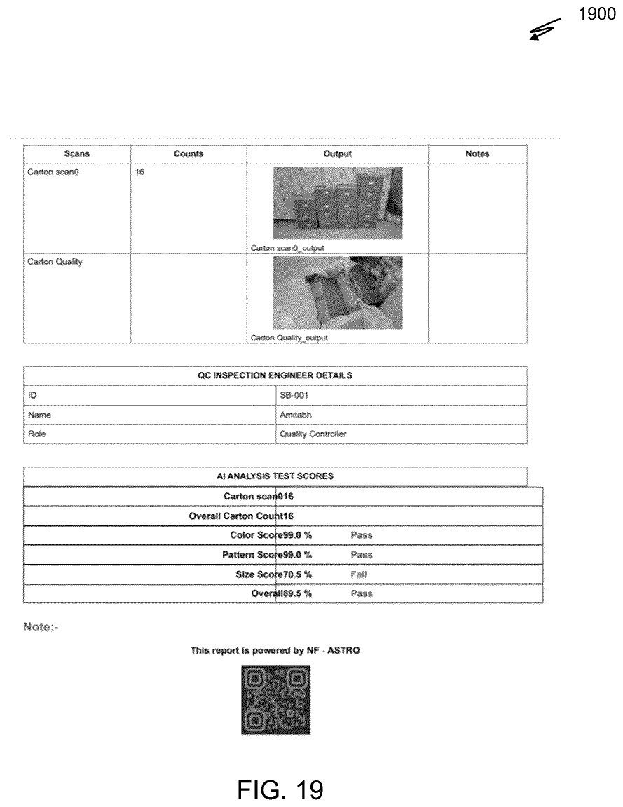

FIG. 19 depicts a pictorial representation of a QA report 1900 illustrating inspection details and AI analysis test scores, in accordance with an embodiment of the present disclosure. The QA report 1900 is generated, through the iQA platform 114, after the quality inspection of the packaged goods or the manufacturing products is completed by the designated user 102. As shown in FIG. 19, the QA report 1900 lists the information related with the quality controller name, quality controller ID, AI analysis test scores, number of counts related to scanning of a particular carton, images of the carton depicting carton quality, and the like. The information related with the AI analysis test scores are, but not limited to, overall carton count, colour score, pattern score, size score, overall score, and final QA status corresponding to each of the scores. For instance, the QA report lists out the overall carton count as 16, the colour score as 99%, the pattern score as 99%, the size score as 70.5%, and the overall score as 89.5%. Additionally, the final QA status corresponding to the colour score, the pattern score, and the overall score is displayed as “PASS”, and the final status corresponding to the size score is displayed as “FAIL”, which indicates that the packaged good or the manufacturing product after the QA is performed qualifies in terms of the colour, the pattern, and overall characteristics, but fails in terms of size characteristics as there is some defect in the size of the packaged good or the manufacturing product.

In the system 100A of the present invention, the computing environment 108 is defined based on cloud resources (infrastructure), and/or applications of the cloud environment. For example, a cloud resources state can include computing devices (e.g., servers), network devices, and/or storage devices deployed in the computing environment 108. An application state can include application installation(s), configuration(s), and interaction(s) (e.g., applications communicating with one another) within the computing environment 108.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

What is claimed is:

1. A system for performing QA of different manufacturing products, comprising:
a client device;
a user device coupled to the client device; and
a computer-readable storage device coupled to the client device, the user device, and one or more processors, and having instructions stored thereon which, when executed by the one or more processors, cause the one or more processors to perform operations performed by an intelligent QA (iQA) platform executed by the one or more processors, the operations comprising:
uploading a picture order (PO) sheet of at least one packaged good or manufacturing product to be inspected at an inspection location facility, through the client device, wherein the PO sheet is indicative of a desired state of a computing environment;
receiving the PO sheet by a designated user through Mixed Reality (MR) glasses;
capturing images of the at least one packaged good or manufacturing product listed in the picture order sheet for inspection;
performing running of cloud functions of the computing environment by the designated user on the captured images, through the iQA platform to determine image characteristics of the at least one packaged good or manufacturing product;
comparing the image characteristics of the at least one packaged good or manufacturing product with image of the at least one packaged good or manufacturing product in the uploaded PO sheet, through the iQA platform;
detecting defects in the packaged goods or manufacturing products, through the iQA platform based on comparison of the determined image characteristics of the at least one packaged good or manufacturing product with the image of the at least one packaged good or manufacturing product in the uploaded PO sheet;
generating a QA report based on the detected defects in the at least one packaged good or manufacturing product, through a QA report generator; and
determining a plurality of scores or grades associated with the at least one packaged good or manufacturing product based on the generated QA report, through a QA report analyzer.

2. The system of claim 1, wherein the PO sheet comprises of a list of packaged goods or manufactured products received by the client for inspection, a list of packaged goods or manufactured products which have been already inspected by the designated user, and a list of packaged goods or manufacturing products in the carton to be picked up by the designated user for inspection.

3. The system of claim 1, wherein the client device comprises of a client database and a web API, the client database configured to store data records related with the list of packaged goods or manufactured products received by the client for inspection, the list of packaged goods or manufactured products which have been already inspected by the designated user, and the list of packaged goods or manufacturing products in the carton to be picked up by the designated user for testing.

4. The system of claim 1, wherein the user device is configured to run through a voice assistant, to take instructions from the client and enable the designated user to provide voice comments to be incorporated in the QA report.

5. The system of claim 1, wherein the MR glasses are configured to be worn by the designated user to see through packaged goods or manufacturing products clearly, and randomly select any packaged good or manufacturing product from catalogue or scheduled tests option in the iQA platform.

6. The system of claim 5, wherein the scheduled tests are the tests scheduled by the designated user or other users through google calendar, or their own calendar, or third-party calendars.

7. The system of claim 1, wherein the iQA platform is configured to enable the designated user to carry out the QA of the packaged goods or manufacturing products, by providing different control options to the designated user, through the computing environment.

8. The system of claim 7, wherein the different control options are, but not limited to, local process, SOP, cloud functions, feedback, and the voice comments.

9. The system of claim 1, wherein the client device is communicably coupled with the user device to guide the designated user, by giving instructions related with performing of the QA of the packaged goods or manufacturing products.

10. The system of claim 3, wherein the web API is configured to enable the client to select different options for controlling process of the QA to be performed by the designated user.

11. The system of claim 10, wherein the different options selected are, but not limited to, image database option, AQL parameters option, activity log option, and weights and biases option.

12. The system of claim 1, wherein the iQA platform comprises a live QA feature, through which the client goes live with the QA process, and passes instructions to the designated user for performing the QA of the packaged goods or manufacturing products.

13. The system of claim 1, wherein the image characteristics of the packaged goods or manufacturing products are, but not limited to, colour, shape, size, pattern, and product labelling associated with the one or more packaged goods or manufacturing products.

14. The system of claim 1, wherein the iQA platform is further configured to detect location of the designated user and a specific time at which the designated user initiates the QA, while the designated user accesses through the computing environment to carry out the QA of the packaged goods or manufacturing products.

15. A computer-implemented method of performing QA of different manufacturing products by an iQA platform executed by one or more processors, the computer-implemented method comprising:
uploading a picture order (PO) sheet of at least one packaged good or manufacturing product to be inspected at an inspection location facility, through a client device, wherein the PO sheet is indicative of a desired state of a computing environment;
receiving the PO sheet by a designated user through MR glasses;
capturing images of the at least one packaged good or manufacturing product listed in the picture order sheet for inspection;
performing running of cloud functions of the computing environment by the designated user on the captured images, through the iQA platform to determine image characteristics of the at least one packaged good or manufacturing product;
comparing the image characteristics of the at least one packaged good or manufacturing product with image of the at least one packaged good or manufacturing product in the uploaded PO sheet, through the iQA platform;
detecting defects in the packaged goods or manufacturing products, through the iQA platform based on comparison of the determined image characteristics of the at least one packaged good or manufacturing product with the image of the at least one packaged good or manufacturing product in the uploaded PO sheet;
generating a QA report based on the detected defects in the at least one packaged good or manufacturing product, through a QA report generator; and
determining a plurality of scores or grades associated with the at least one packaged good or manufacturing product based on the generated QA report, through a QA report analyzer.

16. The method of claim 15, wherein the process of uploading of the PO sheet through the client device comprises accessing the iQA platform by the client using account credentials, and displaying the PO sheet upon successful account verification of the client.

17. The method of claim 15, wherein the process of receiving the PO sheet by the designated user through the MR glasses comprises:
enabling the designated user to get access to the picture order sheet, through the client device; and
displaying the PO sheet to the designated user, through the MR glasses.

18. The method of claim 15, wherein the process of determining the plurality of scores or grades associated with the at least one packaged good or manufacturing product based on the generated QA report, through the QA report analyzer comprises:
enabling the designated user to carry out the QA of the packaged goods or manufacturing products, by providing different control options to the designated user, through the iQA platform.

19. The method of claim 15, wherein the process of generating the QA report based on the detected defects in the at least one packaged good or manufacturing product, through the QA report generator further comprises:
analyzing the QA report, through the QA report analyzer, by comparing the QA report with the image of the at least one packaged good or manufacturing product in the PO sheet; and
collecting data related with the QA of the at least one packaged good or manufacturing product, through a data collector.

20. The method of claim 18, wherein the different control options are, but not limited to, local process, SOP, cloud functions, feedback, and voice comments.

21. The method of claim 15, wherein the process of determining the plurality of scores or grades associated with the at least one packaged good or manufacturing product based on the generated QA report, through the QA report analyzer further comprises:
classifying the quality of the at least one packaged good or manufacturing product under a specific category, through the QA report analyzer; and
displaying the specific category of the at least one packaged good or manufacturing product, through the iQA platform.

22. The method of claim 21, wherein the specific category of the at least one packaged good or manufacturing product comprises classification level of the at least one packaged good or manufacturing product.

23. The method of claim 15, wherein the PO sheet comprises of a list of packaged goods or manufactured products received by the client for inspection, a list of packaged goods or manufactured products which have been already inspected by the designated user, and a list of packaged goods or manufacturing products in the carton to be picked up by the designated user for inspection.

24. The method of claim 15, wherein the step of performing running of cloud functions of the computing environment by the designated user on the captured images, through the iQA platform to determine the image characteristics of the at least one packaged good or manufacturing product further comprises:
detecting location of the designated user and a specific time at which the designated user initiates the QA, through the iQA platform, while the designated user logs in through the iQA platform to carry out the QA of the packaged goods or manufacturing products.

25. A non-transitory computer-readable storage medium coupled to one or more processors and having instructions stored thereon which, when executed by the one or more processors, cause the one or more processors to perform operations performed by an iQA platform executed by the one or more processors, the operations comprising:
uploading a picture order (PO) sheet of at least one packaged good or manufacturing product to be inspected at an inspection location facility, through a client device, wherein the PO sheet is indicative of a desired state of a computing environment;
receiving the PO sheet by a designated user through MR glasses;
capturing images of the at least one packaged good or manufacturing product listed in the picture order sheet for inspection;
performing running of cloud functions of the computing environment by the designated user on the captured images, through the iQA platform to determine image characteristics of the at least one packaged good or manufacturing product;
comparing the image characteristics of the at least one packaged good or manufacturing product with image of the at least one packaged good or manufacturing product in the uploaded PO sheet, through the iQA platform;
detecting defects in the packaged goods or manufacturing products, through the iQA platform based on comparison of the determined image characteristics of the at least one packaged good or manufacturing product with the image of the at least one packaged good or manufacturing product in the uploaded PO sheet;
generating a QA report based on the detected defects in the at least one packaged good or manufacturing product, through a QA report generator; and
determining a plurality of scores or grades associated with the at least one packaged good or manufacturing product based on the generated QA report, through a QA report analyzer.
